(19) United States
(12) Patent Application Publication
(10) Pub. No.: US 2009/0094394 A1
(43) Pub. Date: Apr. 9, 2009

(54) TRANSMISSION CABLE CAPABLE OF TRANSMITTING E-SATA SIGNALS AND ELECTRICITY

(76) Inventors: Chien-Te Wu, Yilan County (TW); Chia-Fu Chan, Taoyuan County (TW); Yu-Lin Liu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/019,641

(22) Filed: Jan. 25, 2008

(30) Foreign Application Priority Data
Oct. 3, 2007 (TW) 096216510

(51) Int. Cl. G06F 13/12

(52) U.S. Cl. 710/72

(57) ABSTRACT

A transmission cable includes a first plug including a housing. A slot is formed inside the housing. The first plug further includes an E-SATA terminal set disposed on a side of the slot for transmitting E-SATA signals, and a power terminal set disposed on the other side of the slot for receiving electricity. The transmission cable further includes an E-SATA signal line electrically connected to the E-SATA terminal set for transmitting the E-SATA signals, a second plug connected to the E-SATA signal line for inserting into a signal receptacle of a E-SATA peripheral device, a power line electrically connected to the power terminal set for transmitting the electricity, and a third plug connected to the power line for inserting into a power receptacle of the E-SATA peripheral device so as to transmit the electricity to the E-SATA peripheral device.

### BACKGROUND OF THE INVENTION

1. Field of the Invention

The present invention relates to a transmission cable, and more particularly, to a transmission cable capable of transmitting E-SATA signals and electricity simultaneously.

2. Description of the Prior Art

With advanced development of computer technology, the size of a computer system is gradually being reduced. The computer system is now used in a broad spectrum of fields. In order to expand additional functions of the computer system to meet requirements of different users, many kinds of external devices are invented under this situation. For example, an external hard disk drive or other portable data storage devices can increase the total data storage capacity of the computer system. An external optical drive and an external optical recordable drive can provide the computer system with an additional ability of accessing multimedia data recorded on compact discs and storing a great quantity of back-up data on the compact disc. However, in order to enable the external storage device capable to work normally, a basic requirement is establishing an effective data transmission interface for the host system capable of transmitting data with various storage devices efficiently. Therefore, a variety of industry standard transmission protocols have been developed and are currently in use, such as versions of a Universal Serial Bus (USB), IEEE 1394, and external serial ATA (E-SATA) interfaces as a few examples. In this situation, an intermediate device, or bridge, is often used between the storage device and the host system to permit effective data transmission. E-SATA interface conforms to a transmission protocol with the plug and play characteristic, and a theoretical transmission rate can reach 1.5 GPS. E-SATA interface is a data transmission interface with high transmission rate and is widely utilized in external peripheral devices with high transmission rate.

Please refer to FIG. 1. FIG. 1 is a diagram of a host 10 connecting with an E-SATA peripheral device 12 externally in the prior art. The host 10 can be a computer, such as a notebook computer. The E-SATA peripheral device 12 can be an external hard disk, an external optical drive, an external scanner in E-SATA interface, and so on. The host 10 and the E-SATA peripheral device 12 are electrically connected via a transmission cable 14 for transmitting E-SATA signals. That is, the host 10 can transmit data stored in the host 10 to the E-SATA peripheral device 12 via the transmission cable 14, or the host 10 can access data stored in the E-SATA peripheral device 12 via the transmission cable 14. The E-SATA peripheral device 12 is electrically connected to an external power supply 18 via a power cable 16 additionally for receiving electricity. That is, the transmission cable 14 only transmit the E-SATA signals between the host 10 and the E-SATA peripheral device 12, and there is a need for the E-SATA peripheral device 12 to utilize the power cable 16 for receiving the electricity from the external power supply 18. It is inconvenient for the user to use the host 10 electrically connected to the external E-SATA peripheral device 12 especially when the E-SATA peripheral device 12 is using in a condition without the external power supply 18.

### SUMMARY OF THE INVENTION

It is therefore a primary objective of the claimed invention to provide a transmission cable capable of transmitting E-SATA signals and electricity simultaneously for solving the above-mentioned problem.

According to the claimed invention, a transmission cable includes a first plug including a housing. A slot is formed inside the housing. The first plug further includes an E-SATA terminal set disposed on a side of the slot for transmitting E-SATA signals, and a power terminal set disposed on the other side of the slot for receiving electricity. The transmission cable further includes an E-SATA signal line electrically connected to the E-SATA terminal set for transmitting the E-SATA signals, a second plug connected to the E-SATA signal line for inserting into a signal receptacle of a E-SATA peripheral device, a power line electrically connected to the power terminal set for transmitting the electricity, and a third plug connected to the power line for inserting into a power receptacle of the E-SATA peripheral device so as to transmit the electricity to the E-SATA peripheral device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a host connecting with an E-SATA peripheral device externally in the prior art.

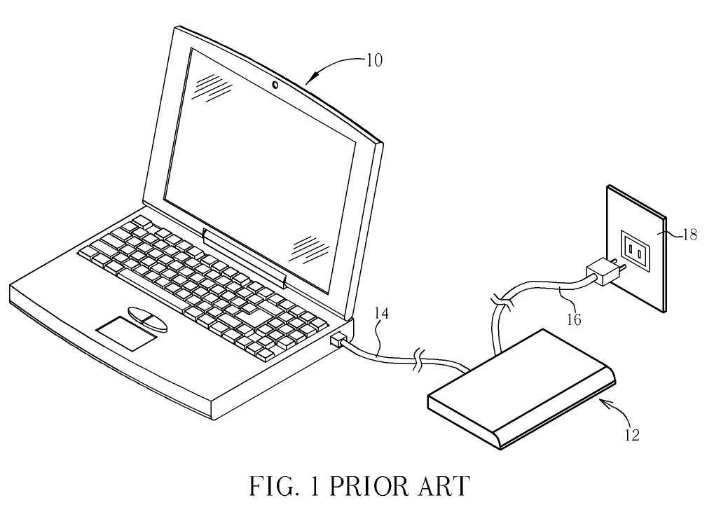

FIG. 2 is a diagram of a host connecting with an E-SATA peripheral device externally according to an embodiment of the present invention.

FIG. 3 is a functional block diagram of the host connecting with the E-SATA peripheral device externally according to the embodiment of the present invention.

FIG. 4 is a diagram of a connector on a circuit board according to the embodiment of the present invention.

FIG. 5 is a schematic drawing of a transmission cable according to the embodiment of the present invention.

FIG. 6 is a diagram of a first plug according to the embodiment of the present invention.

### DETAILED DESCRIPTION

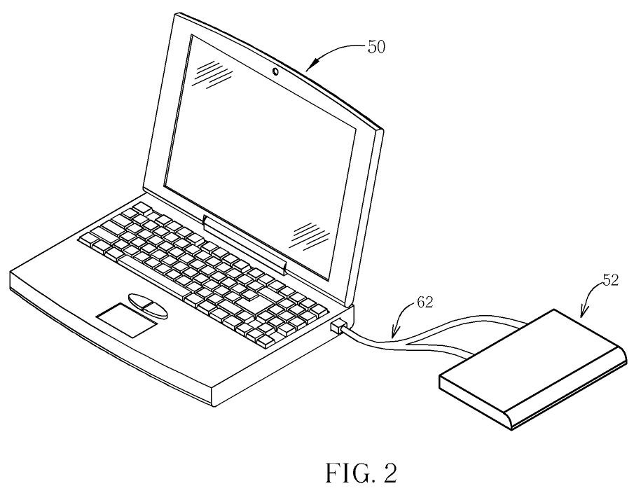

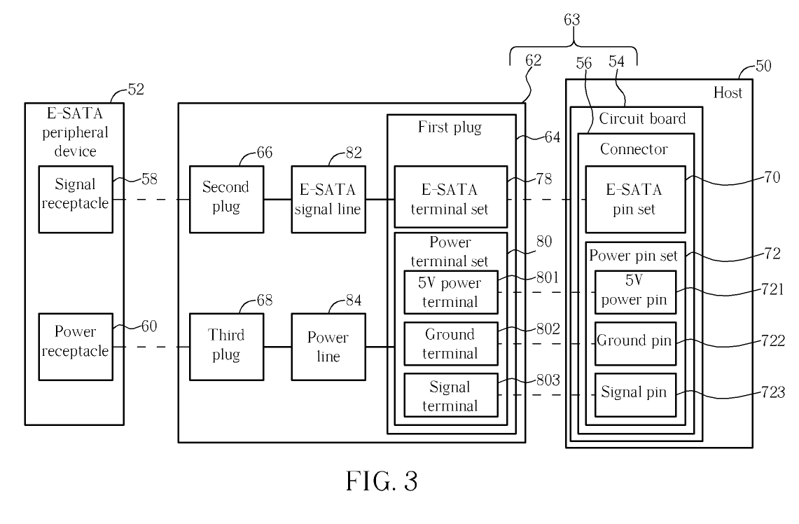

Please refer to FIG. 2 and FIG. 3. FIG. 2 is a diagram of a host 50 connecting with an E-SATA peripheral device 52 externally according to an embodiment of the present invention. FIG. 3 is a functional block diagram of the host 50 connecting with the E-SATA peripheral device 52 externally according to the embodiment of the present invention. The host 50 can be a computer, such as a notebook computer. The E-SATA peripheral device 52 can be an external hard disk, an external optical drive, an external scanner in E-SATA interface, and so on. The host 50 includes a circuit board 54 which can be a motherboard, and a connector 56 installed on the circuit board 54. The E-SATA peripheral device 52 includes a signal receptacle 58 and a power receptacle 60. The host 50 and the E-SATA peripheral device 52 are electrically connected via a transmission cable 62 for transmitting E-SATA signals and electricity. A transmission system 63 includes the circuit board 54, the connector 56, and the transmission cable 62. The transmission cable 62 includes a first plug 64, a second plug 66, and a third plug 68. The first plug 64 is for connecting with the connector 56 of the host 50. The second plug 66 is for connecting with the signal receptacle 58 of the E-SATA peripheral device 52. The third plug 68 is for connecting with the power receptacle 60 of the E-SATA peripheral device 52.

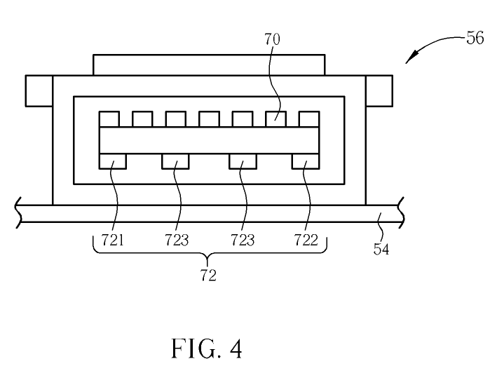

Please refer to FIG. 4. FIG. 4 is a diagram of the connector 56 on the circuit board 54 according to the embodiment of the present invention. The connector 56 includes an E-SATA pin set 70 and a power pin set 72. The E-SATA pin set 70 includes seven pins. The first, fourth, seventh pins counted from the left side are ground pins, and the second, third, fifth, sixth pins counted from the left side are pins for transmitting signals. The power pin set 72 can conform to USB interface. Thus, the first pin and the fourth pin counted from the left side are a 5V power pin 721 and a ground pin 722 respectively, and the second pin and the third pin counted from the left side are two signal pins 723 for detecting whether the host 50 can provide the electricity to the E-SATA peripheral device 52. The two signal pins 723 are disposed selectively, that is, the power pin set 72 can only include the 5V power pin 721 and the ground pin 722.

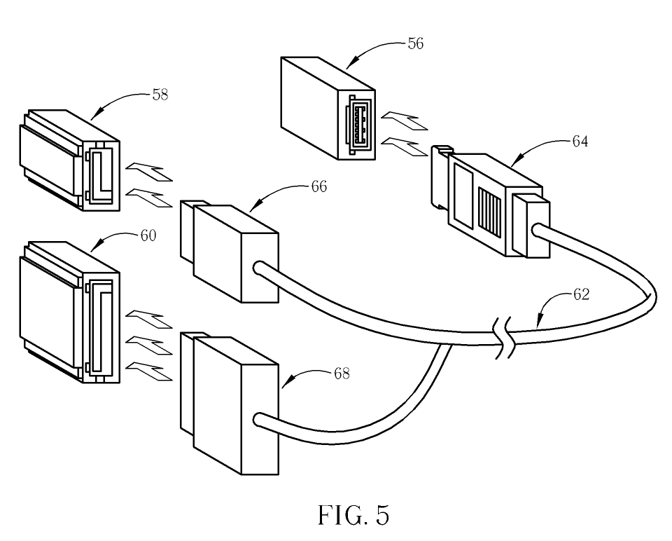

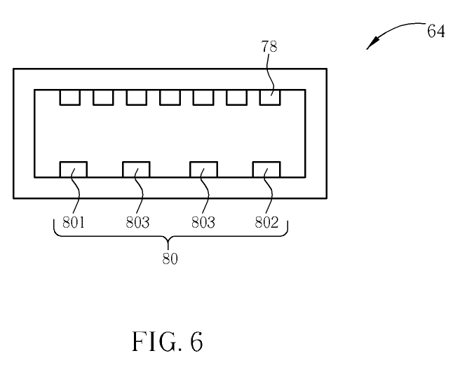

Please refer to FIG. 5 and FIG. 6. FIG. 5 is a schematic drawing of the transmission cable 62 according to the embodiment of the present invention. FIG. 6 is a diagram of the first plug 64 according to the embodiment of the present invention. The first plug 64 is for inserting into the connector 56 of the host 50. The first plug 64 includes a housing 74. A slot 76 is formed inside the housing 74. The first plug 64 further includes an E-SATA terminal set 78 disposed on a side of the slot 76 for electrically connecting with the E-SATA pin set 70 of the connector 56 so as to transmit E-SATA signals, and a power terminal set 80 disposed on the other side of the slot 76 for electrically connecting with the power pin set 72 so as to receive electricity. In correspondence with the connector 56, the E-SATA terminal set 78 includes seven pins. The first, fourth, seventh pins counted from the left side are ground pins, and the second, third, fifth, sixth pins counted from the left side are pins for transmitting the E-SATA signals with the corresponding pins of the connector 56. The power terminal set 80 can conform to USB interface. Thus, the first pin and the fourth pin counted from the left side are a 5V power terminal 801 and a ground terminal 802 respectively, and the second pin and the third pin counted from the left side are two signal terminals 803. The 5V power terminal 801 is for connecting with the 5V power pin 721 of the connector 56, and the ground terminal 802 is for connecting with the ground terminal 722 of the connector 56. The signal terminals 803 are for connecting with the signal pins 723 of the connector 56 for detecting whether the host 50 can provide the electricity to the E-SATA peripheral device 52. The two signal terminals 803 are disposed selectively, that is, the power terminal set 80 can only include the 5V power terminal 801 and the ground terminal 802. When the first plug 64 is inserted into the connector 56, the E-SATA terminal set 78 contacts with the E-SATA pin set 70 and the power terminal set 80 contacts with the power pin set 72 so that the E-SATA signals and the electricity can be transmitted between the host 50 and the E-SATA peripheral device 52 simultaneously via the transmission cable 62.

Please continue referring to FIG. 2 to FIG. 6. The transmission cable 62 further includes an E-SATA signal line 82 electrically connected to the E-SATA terminal set 78 and the second plug 66 for transmitting E-SATA signals, and a power line 84 electrically connected to the power terminal set 80 and the third plug 68 for transmitting electricity. When the first plug 64 is inserted into the connector 56 and the second plug 66 is inserted into the signal receptacle 58, the E-SATA terminal set 78 contacts with the E-SATA pin set 70 so that the E-SATA signals can be transmitted between the host 50 and the E-SATA peripheral device 52 via the E-SATA pin set 70 of the connector 56, the E-SATA terminal set 78 of the first plug 64, the E-SATA signal line 82, the second plug 66, and the signal receptacle 58. When the first plug 64 is inserted into the connector 56 and the third plug 68 is inserted into the power receptacle 60, the power terminal set 80 contacts with the power pin set 72 so that the electricity can be transmitted from the host 50 to the E-SATA peripheral device 52 via the power pin set 72 of the connector 56, the power terminal set 80 of the first plug 64, the power line 84, the third plug 68, and the power receptacle 60. That is, when the first plug 64 of the transmission cable 62, the second plug 66, and the third plug 68 are inserted into the connector 56 of the host 50, the signal receptacle 58 of the E-SATA peripheral device 52, and the power receptacle 60 of the E-SATA peripheral device 52 respectively, the E-SATA signals and the electricity can be transmitted via the transmission cable 62 simultaneously between the host 50 and the E-SATA peripheral device 52.

In contrast to the prior art, the present invention provides the transmission cable capable of transmitting E-SATA signals and electricity between the host and the E-SATA peripheral device simultaneously. There is no need to utilize an additional power cable for receiving electricity from an external power supply. It is convenient for the user to use the host electrically connected to the external E-SATA peripheral device especially when the E-SATA peripheral device is using in a condition without the external power supply.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission cable comprising:
a first plug for connecting with a connector of a host, the first plug comprising:
a housing, a slot being formed inside the housing;
an E-SATA terminal set disposed on a side of the slot for transmitting E-SATA signals; and
a power terminal set disposed on the other side of the slot for receiving electricity;
an E-SATA signal line electrically connected to the E-SATA terminal set for transmitting the E-SATA signals;
a second plug connected to the E-SATA signal line for inserting into a signal receptacle of an E-SATA peripheral device;
a power line electrically connected to the power terminal set for transmitting the electricity; and
a third plug connected to the power line for inserting into a power receptacle of the E-SATA peripheral device so as to transmit the electricity to the E-SATA peripheral device.

2. The transmission cable of claim 1 wherein the power terminal set conforms to USB interface.

3. The transmission cable of claim 2 wherein the power terminal set comprises a 5V power terminal, and a ground terminal.

4. The transmission cable of claim 3 wherein the power terminal set further comprises two signal terminals for detecting whether the host can supply the electricity to the E-SATA peripheral device.

5. A transmission system comprising:
a circuit board;
a connector installed on the circuit board, the connector comprising an E-SATA pin set and a power pin set; and
a transmission cable comprising:
a first plug for connecting with the connector, the first plug comprising:
a housing, a slot being formed inside the housing;
an E-SATA terminal set disposed on a side of the slot for electrically connecting with the E-SATA pin set of the connector so as to transmit E-SATA signals; and
a power terminal set disposed on the other side of the slot for electrically connecting with the power pin set of the connector so as to receive electricity;
an E-SATA signal line electrically connected to the E-SATA terminal set for transmitting the E-SATA signals;
a second plug connected to the E-SATA signal line for inserting into a signal receptacle of an E-SATA peripheral device;
a power line electrically connected to the power terminal set for transmitting the electricity; and
a third plug connected to the power line for inserting into a power receptacle of the E-SATA peripheral device so as to transmit the electricity to the E-SATA peripheral device.

6. The transmission system of claim 5 wherein the power pin set of the connector conforms to USB interface, and the power terminal set conforms to USB interface.

7. The transmission system of claim 6 wherein the power pin set comprises a 5V power pin and a ground pin, and the power terminal set comprises a 5V power terminal for electrically connecting with the 5V power pin, and a ground terminal for electrically connecting with the ground pin.

8. The transmission system of claim 7 wherein the power terminal set further comprises two signal terminals for detecting whether the circuit board can supply the electricity to the E-SATA peripheral device.
